(19) United States
(12) Patent Application Publication
(10) Pub. No.: US 2013/0073104 A1
(43) Pub. Date: Mar. 21, 2013

(54) MODULAR INTELLIGENT ENERGY MANAGEMENT, STORAGE AND DISTRIBUTION SYSTEM

(71) Applicant: Maro Sciacchitano, McLean, VA (US)

(72) Inventor: Maro Sciacchitano, McLean, VA (US)

(73) Assignee: Maro Sciacchitano, McLean, VA (US)

(21) Appl. No.: 13/237,150

(22) Filed: Sep. 20, 2011

(51) Int. Cl. G06F 1/26

(52) U.S. Cl. 700/295

(57) ABSTRACT

An intelligent energy management system contains one or more autonomous modules. Modules may be portable or stationary. Each consists of an intelligent controller, power converters, distribution bus, and energy storage unit, and can function independently. The intelligent controller uses artificial intelligent algorithms to learn from past performance and improves itself during operation. The system can interface with a variety of energy sources. When connected together the modules form a micro-grid which manages, stores, and distributes power. Each module in the intelligent micro-grid may be different. Each module may connect to different types of energy generation or contain different energy storage units. The system might consist of modules with energy storage units that may be removable from each module. In another embodiment, energy generation may also be integrated into each module. In another, each module may be used alone or with external energy sources, but without other modules.

### RELATED APPLICATION

None.

### FIELD OF DISCLOSURE

The present disclosure is generally related to the management of energy generation sources and the storage of energy.

### BACKGROUND

Renewable energy sources, such as wind and solar power, are intermittent and unpredictable. Their availability changes with location, time of day, weather and season. Conventional schemes for managing, storing and distributing energy are poorly suited to such resources. These schemes were typically developed for resources that can be easily controlled and predicted, and also assume that the use of power is relatively predictable.

By contrast, power consumption is very unpredictable in many situations where renewable resources are most valuable, such as in remote areas, military outposts, disaster areas, and other situations where portable power generation is used. Additionally, when conventional grid power is available it can be difficult or impossible to interface the portable equipment to the grid. Furthermore, if grid power is available, but unreliable, it can be very hard to operate critical equipment or maintain critical services like well pumps and ventilation systems.

Because of these problems, it has become customary in many situations to constantly idle generators as a way to guarantee a constant supply of energy, even when there is no demand. This solution consumes large quantities of fuel and drives cost up.

There is clearly a need for a flexible and reliable solution which enables the utilization of these complex resources in a simple way. Efficient management of renewable resources requires unconventional methods. The problem also demands novel system level integration in order to ensure that these devices are not too complicated or expensive.

### BRIEF DESCRIPTION OF DRAWINGS

The subject matter which is regarded as the invention is particularly pointed out and distinctly claimed at the conclusion of the specification. The foregoing objects, features, and advantages of the invention described in the following detailed description are illustrated with the accompanying drawings in which:

FIG. 1 shows a system of independent modules, connected together in a ring network, and harnessing several different types of energy generation, including solar, wind and portable generators.

FIG. 2 shows details of an individual module, with particular detail given to the distribution and intelligent controller subsystems.

FIG. 3 shows details of the intelligent controller, including artificial intelligence models and unsupervised active learning loop.

FIG. 4 shows various arrangements of the modules as well as ways in which they may be connected together and communications schemes with local and remote users.

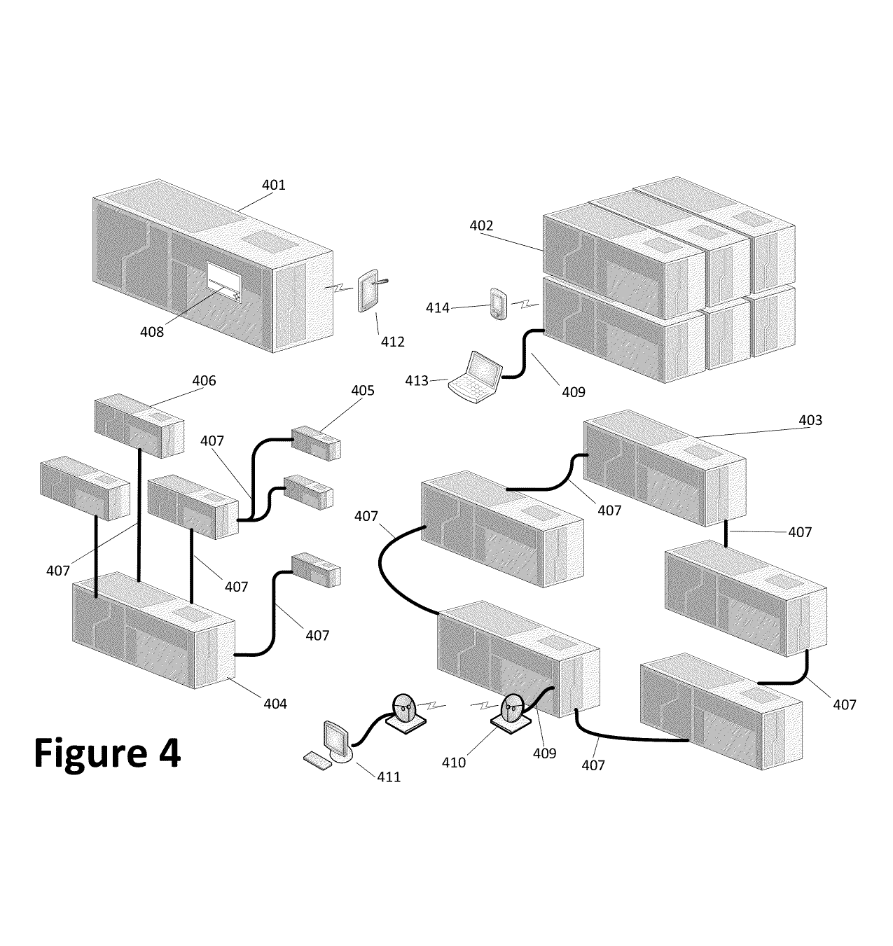

FIG. 5 shows the inventions in various stationary and mobile applications, as well as configured with on-board generation capability and off-board storage.

FIG. 6 shows more embodiments of the invention; a portable backpack version, semi permanent and permanent installations on a building and a modular version that can be broken down into constituent components and reassembled.

### BRIEF DESCRIPTION OF THE INVENTION

An embodiment of the Intelligent Energy Management, Storage and Distribution System may be a collection of modules which manage energy sources, and store and distribute energy. Each module may be comprised of an intelligent controller, a power distribution subsystem and a storage subsystem. These three parts may be integrated into a single mechanical package. Additional storage may be connected remotely.

The power distribution subsystem distributes power to the user, and may consist of alternating current, direct current, 3-phase, pulse-width modulated power, multiphase power, pulsed power, or some combination of these. The power distribution subsystem includes safety features such as fuses, circuit breakers, ground fault detectors, ground fault interrupters, short circuit protection and other safety measures.

The storage subsystem may utilize batteries, capacitors, ultracapcitors, fuel cells, pneumatic or hydraulic storage, fly wheels, or any other regenerative energy storage technology. The storage subsystem may also unitize hybrid arrangements of two or more of these technologies.

The Intelligent Controller subsystem ties all of the pieces together: It optimizes energy resources; provides basic thermal management and maintenance of energy storage; and coordinates supply distribution and energy conservation with the other modules. The controller includes hardware that gathers data about system performance and usage as well as information about the current location and weather, weather predictions and energy cost trends, utilizing both internal databases and remote information, such as cloud based or internet based archives. The artificial intelligent algorithms use this information to decide how to best use energy as it is generated. The performance of these algorithms may be evaluated by the intelligent controller software, and adjustments may be continuously made to improve performance. The controller may be designed to be multiply redundant and uses a weighted voting system to guarantee optimal, failsafe performance. The intelligent controller also incorporates safety features such as resettable circuit breakers and fuses as well as ground fault detectors and interrupters, and thermal overload protection. In any embodiment, if modules are to communicate with each other, they may use either wired or wireless communication technology, or a combination. Examples include various Ethernet protocols, IEEE 802.11 standards, Zigbee, CAN-Bus, RS-485, RS-232, fiber-optic, universal serial bus, or similar technologies. The system does not necessarily require any communication with external power sources, but may utilize such communication depending on the exact embodiment of the invention.

The goal of the invention is to replicate the experience of using a wall socket. Plug-in and the power is always there. All of the complex tasks can be hidden from the user. The intelligent controller may also be where power sources are connected. These sources may include grid power from a power plant, portable or stationary generators using fossil fuels, photovoltaic panels, wind turbines, fuel cells, thermoelectric generators, micro-turbines, hydroelectric generators, radiothermal generators, or any combination of generation technology.

Another embodiment of the invention consists of a system of modules, each containing a controller, power distribution, and storage, connected together in a storage and distribution ring to create a micro-grid. Single point failures do not affect other points on the ring, and if one module's storage system fails, power is not interrupted to loads connected to that module.

The arrangement allows modules to share power more efficiently. Only some of the modules need to be connected to power generators with no manual load balancing because the entire system behaves as a single power supply. Modules come on or off grid without shutting down other parts of the grid, a critical feature when power interruptions may pose serious risks. The modules can also be deployed in any configuration. In addition and critically, each module can still function totally independently. This enhances system robustness, and allows the system to scale up as power requirements change.

A third embodiment may be a system where storage may be removable or completely remote.

In a forth embodiment generation and storage may be both mechanically integrated into a single unit along with the power distribution and intelligent controller subsystem. Generation could be any of those technologies previously listed.

Mechanically, any of the above described embodiments may be designed as stationary or portable systems. The mechanical structure may be designed for use outdoors and can be weatherproof or completely submersible for river or marine use. The invention can be mounted on a trailer or installed in a vehicle such as a car, truck, aircraft, boat, ship or spacecraft. The system may be designed to be temporarily, semi-permanently or permanently installed outside, on, or inside a building. The structural materials may be metal or composite framing. The mechanical structure includes thermal management and duct work designed into the structure. Each module may be protected by an Automatic Fire Extinguishing System (AFES).

### DETAILED DESCRIPTION OF THE INVENTION

With reference to the accompanying Figures, examples of an energy management and storage system and method, according to embodiments of the invention, are disclosed. For purposes of explanation numerous specific details are shown in the drawings and set forth in the detailed description that follows in order to provide a thorough understanding of embodiments of the invention. It will be apparent, however, that embodiments of the invention may be practiced without these specific details. In other instances well known structures and devices are schematically shown in order to simplify the drawing.

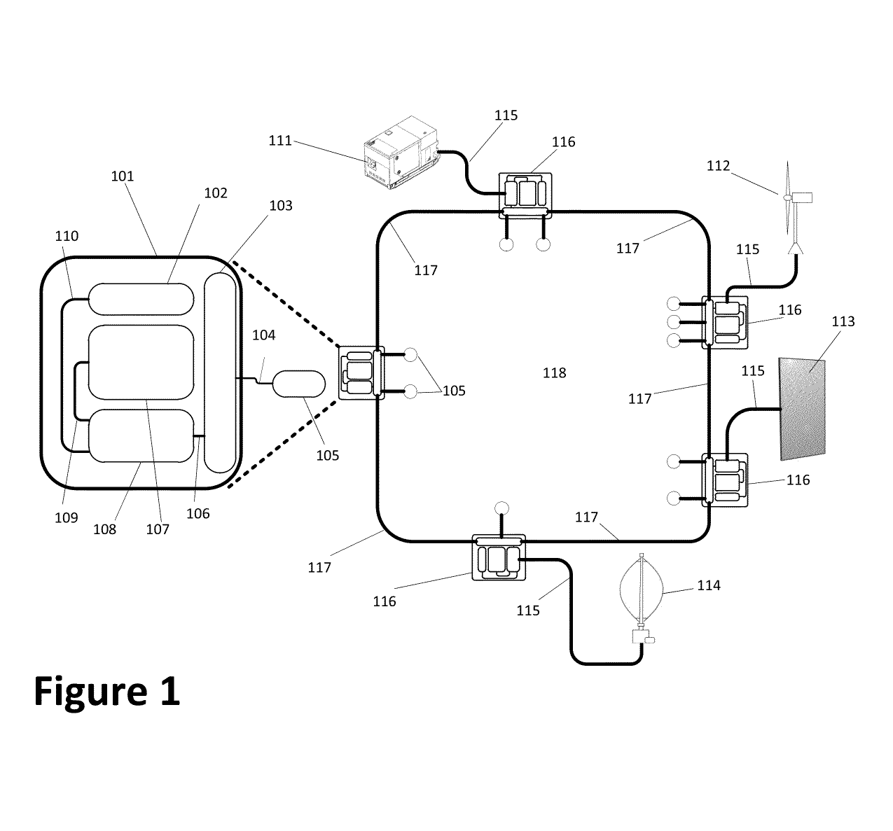

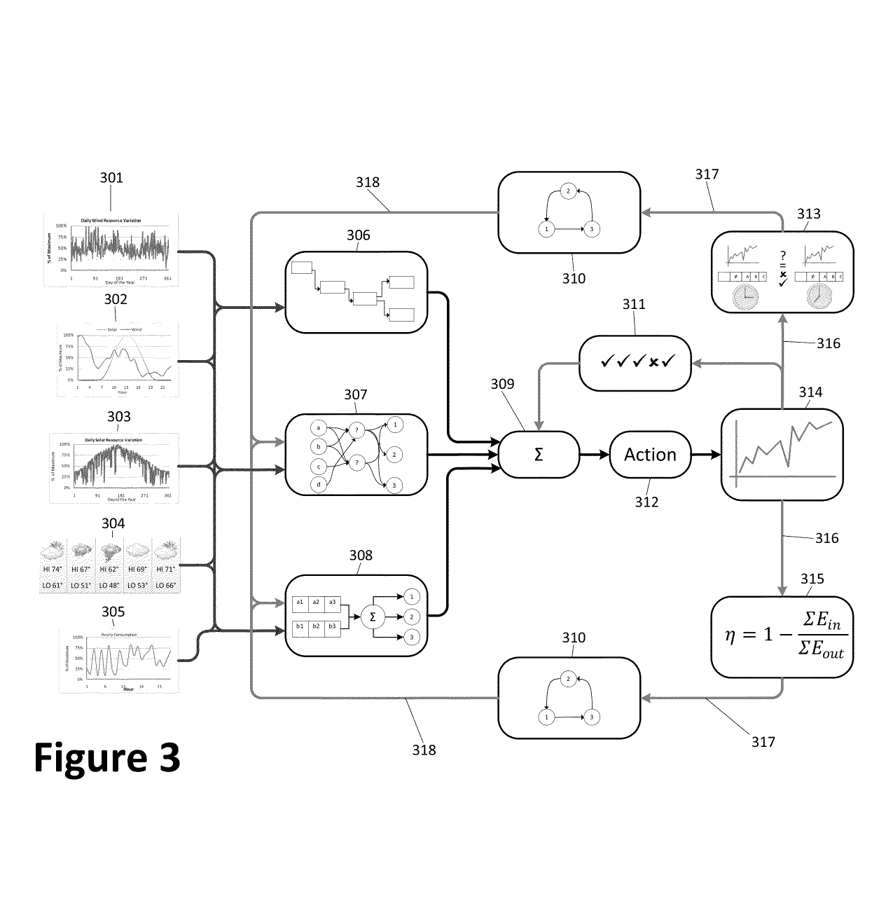

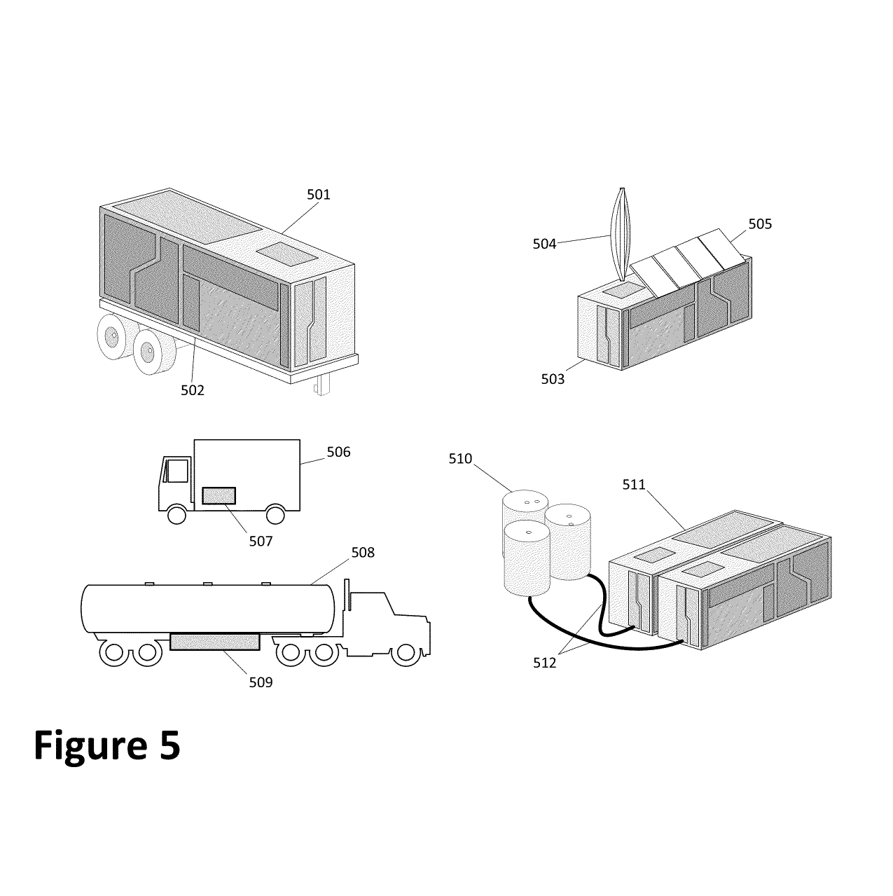

Shown in FIG. 1 an embodiment of the invention may be a system 118 of one or more modules 116 which manage energy sources 111-114, and store 102, 107 energy, and distribute 103 energy utilizing artificial intelligence algorithms, FIG. 3, 307, 308, to optimize performance and improve reliability over conventional systems. Energy may be distributed 104 to user devices 105 via the distribution system 103. The modules 101 may be completely integrated, independent units, and in all embodiments may function independently or in concert, depending on the configuration. Each module may be comprised of an intelligent controller 108, a power distribution subsystem 103 and a storage subsystem 107, 108. These three parts may be integrated into a single mechanical package 101. Additional storage may be connected remotely as shown in FIG. 5, 510. When connected together 117 the modules may share information and act cooperatively to manage and share resources efficiently. However they maintain autonomy and can be disconnected from the system at any time.

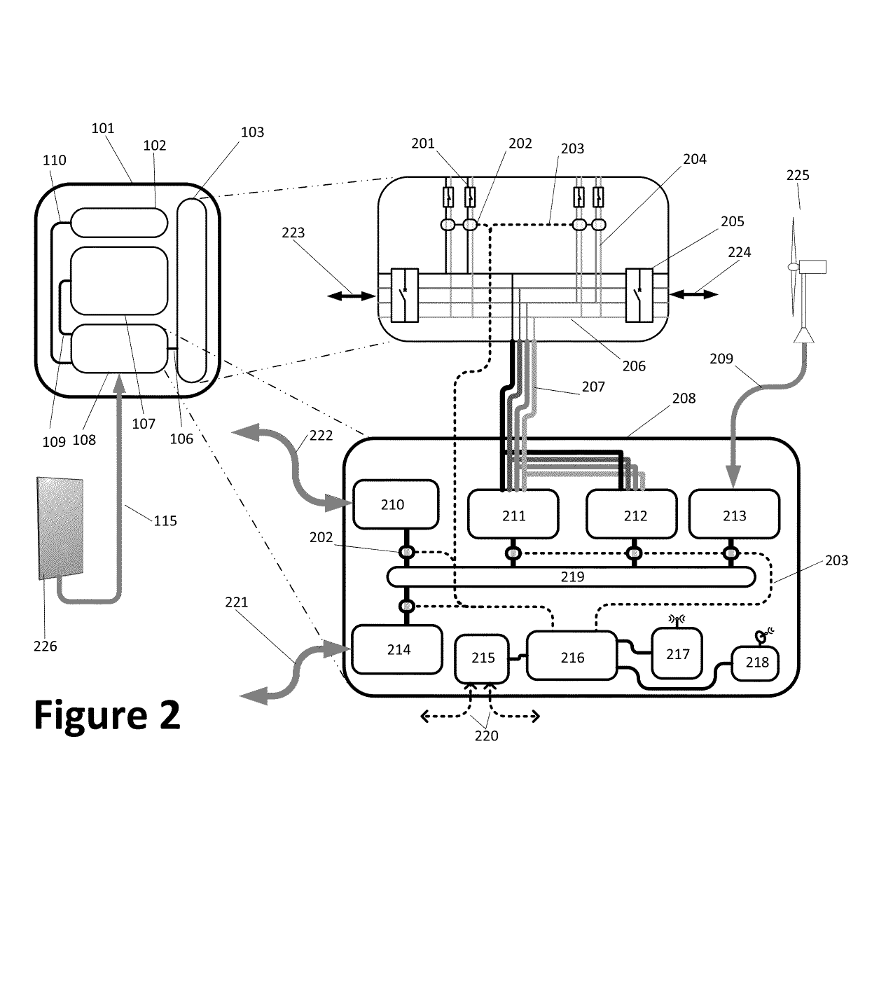

The power distribution subsystem, as show in FIG. 2, distributes power to the user, and may consist of alternating current, direct current, 3-phase, pulse-width modulated power, multiphase power, pulsed power, wireless transfer, or some combination of these 204, 206. Additionally, if energy is being stored by non-electrical means, or the system is providing combined heat and power or any combination of services, these services may be shared over the power distribution subsystem. These may include pneumatic fluids, hydraulic fluids, or fluids for heating and cooling. When connected to other modules this subsystem also sends 223 and receives power from them 224. The power distribution subsystem includes safety features such as fuses, circuit breakers, ground fault detectors, ground fault interrupters, short circuit protection and other safety measures 201, 205.

The storage subsystem may utilize a variety of technologies 102, 107 including batteries, capacitors, ultracapcitors, fuel cells, pneumatic or hydraulic storage, fly wheels, or any other regenerative energy storage technology. The storage subsystem may also convert one form of energy to another. For instance, if the incoming source of energy is heat from an external boiler, the energy storage subsystem may either store this heat directly, or convert it to electrical energy for storage using various methods. The storage subsystem may also unitize hybrid arrangements of two or more of these technologies. Additionally the system may manage a storage system that provides cogenerated heating or hot water as a byproduct of energy storage. The storage subsystem may be removable and/or replaceable, and may include a hot swappable design wherein the system stays operational while a an individual storage subsystem is removed or added, the modules remain operational while they are removed or added, or both.

Shown in FIG. 2 The Intelligent Controller subsystem 208 may be comprised of a computer or multiple computers, embedded micro-control or other logic device 216 that contains the artificial intelligence algorithms 307, 308, power conversion devices for each input 212 213 and output 211, charging and discharge hardware for the storage subsystem 210, 214, database 301-305, data acquisition hardware 202, control hardware 203, and communication hardware 215. The controller may be connected to a short term storage subsystem with a data and power connection 222, and may also be connected to a long term energy storage subsystem 221. The database may be comprised of many different types of data sets, including location specific information such as annual wind 301 and insolation 303 trends, hourly expected wind and sun 302, forecast data 304, site specific performance data or historic usage trends 305, grid energy cost trends and other relevant information. The controller may also include a Global Positioning System (GPS) 218 or similar technology and radio receivers 217 to gather data from periodic weather broadcasts and other sources of information. Power may be sent to the user via a bus 207 between the distribution subsystem and the controller. Energy may be collected from external power sources 225 via a connection 209 to a power conversion unit 213. Communication between modules, a remote controller, or network 220 may be achieved through a communications system 215, and may be wired or wireless. All of these components may be integrated into a subsystem which comprises the intelligent controller.

Input and output power converters 210-214 integrated into the intelligent control subsystem 108 may be of isolated or non-isolated types, including transformers, step-up converters, step-down converters, linear type converters, switching converters and buck-boost converters, from alternating current (AC) to direct current (DC), DC to AC, AC to AC, or DC to DC. Additionally power converters may utilize a variety of waveforms and electrical standards, such as single phase, 3-phase power, pulse width modulated power [PWM], multiphase power, pulsed power or direct current, or a combination of these, and at any voltage or combination of voltages. These devices may be either analog or digitally designed, and use solid-state components, resistive, inductive and capacitive components, or some combination of all four types. Additionally power may be transmitted via wireless transmission technology. Energy may be moved inside each module via a bus architecture 219 which may be either AC or DC power or a combination.

The intelligent controller can interface with a variety of third party power generation technology 111-114 including the stationary electrical grid, an independent deployable or stationary micro-grid, generators using fossil fuels, biofuels, hydrogen, photovoltaic panels, wind turbines, fuel cells, heat and power cogeneration units, thermoelectric generators, micro-turbines, hydroelectric generators, radiothermal generators, or any combination of generation technology. It does not require control or communication over these various technologies in order to function. However, in order to optimize operation, some implementations may utilize enhanced data connections. For example, if a back-up generator is connected to the system, it may be possible to use a remote start function to control operation of the generator. The intelligent control subsystem can also interface with third party energy storage devices, with or without data connections.

The controller interfaces 106, 109, 110, with other subsystems via a communications protocol such as Ethernet protocols, IEEE 802.11 standards, Zigbee, CAN-Bus, RS-485, RS-232, fiber-optic, universal serial bus, or similar technologies. It also uses analog and digital control lines 203 to directly manipulate remote control circuit breakers 201, 205, resettable fuses, valves, relays, switches, and any support hardware such as fan's mechanized louvers, vents or covers. The controller uses a variety of data acquisition sensors 202 onboard to determine how best to manage the incoming power 207, 209 and stored energy. The controller may also have thermometers, thermocouples, wind speed sensors, light sensors or solar tracking sensors that allow it to better understand local conditions that affect the performance of energy generating devices.

The artificial intelligence and machine learning algorithms utilized by the intelligent controller, shown in FIG. 3, may be organized into a redundant control scheme that utilizes multiple control strategies 306-308 to produce an exceptionally robust and failsafe architecture by combining control results from each strategy 309. These algorithms may include Markov Modeling, Bayes Classifier models 308, neural networks 307, gradient boosting techniques, random subspace methods, association rule learning, genetic programming methods, inductive logic, fuzzy logic, reinforcement learning or any similar techniques or combination of techniques. The control software actively improves itself through a learning loop, 316-318, by analyzing performance data 314 and comparing it to predicted results 313, 315. These comparisons may then be used to modify 308, 310 the algorithms in real time to improve results. This analysis 308, 310, 212, 213, 315 can be done onboard or by a remote computer or cloud, depending on the implementation of the system. The system also implements a dynamic weighted voting system 311 which may depend on pervious performance results. The redundant system may be further strengthened by using a heuristically programmed control scheme 306 which may be used to produce baseline control strategies for comparison to the novel machine learning strategies. The controller may use these results to minimize or eliminate fuel consumption, minimize reliance or eliminate on grid power, and maximize energy reserves, maximize the availability of power, optimize the operation of external sources of power, optimized the operation of user devices connected to the system, maximize the amount of energy sold to the grid, minimize costs associated with operations, or may balance a number of predefined or user defined objectives. Because the cost of electricity from eternal sources may vary with time of day it may be necessary to consider a combination of factors when determining the optimal mode of operation.

The module may have a user interface in the form of a monitor 408, keyboard and mouse 413, touch-screen 412 or other input device 414. This interface may be physically integrated with the controller 408, or connected remotely via cabled connection 409 such as Ethernet, RS-232, RS-422 or RS-485, CAN-Bus, universal serial bus, Firewire or similar technology, or wireless connections 410 such as IEEE 802.11 (Wi-Fi), Bluetooth, Zigbee, infrared, cellular or satellite communication. The interface may also take the form of a physical device or a software interface, web interface 411 (HTML, Flash or Java), or a mechanical interface.

The intelligent control, storage and distribution subsystems may be integrated together into a single module 101. These individual subsystems 102, 103, 107, 108 may themselves be modular, i.e. removable and replaceable as a single piece. In some embodiments of the system, certain parts of each module may not always be physically integrated into the same mechanical package, but will still be electrically and systemically integrated. As shown in FIG. 5 for example, a large energy storage module 510 may be housed separately for logistical or safety reasons, but will still function as in integral part 512 of the system 511.

These modules in turn may be combined into a power management system shown in FIG. 1, 118. This system may be made up of autonomous units 116 but functions as a single power source, as far as the user 105 is concerned. By forming a micro-grid 104, 117, modules can share energy and data. The number of units connected may be determined by the power, redundancy, and reliability requirements required in a given situation. Modules can be connected and disconnected from this system without turning power off to other modules in the micro-grid, thereby enabling a scalable uninterrupted power system. Modules connected together in this fashion may not be of the same size, capacity or type as shown in figure, 404-407.

As shown in FIG. 5, in some embodiments of the system a power source 504, 505 may be integrated into some or all of the modules 503. This could include a deployable solar array, wind turbine, piston driven or turbine driven generator, thermoelectric or radiothermal device, or other power source.

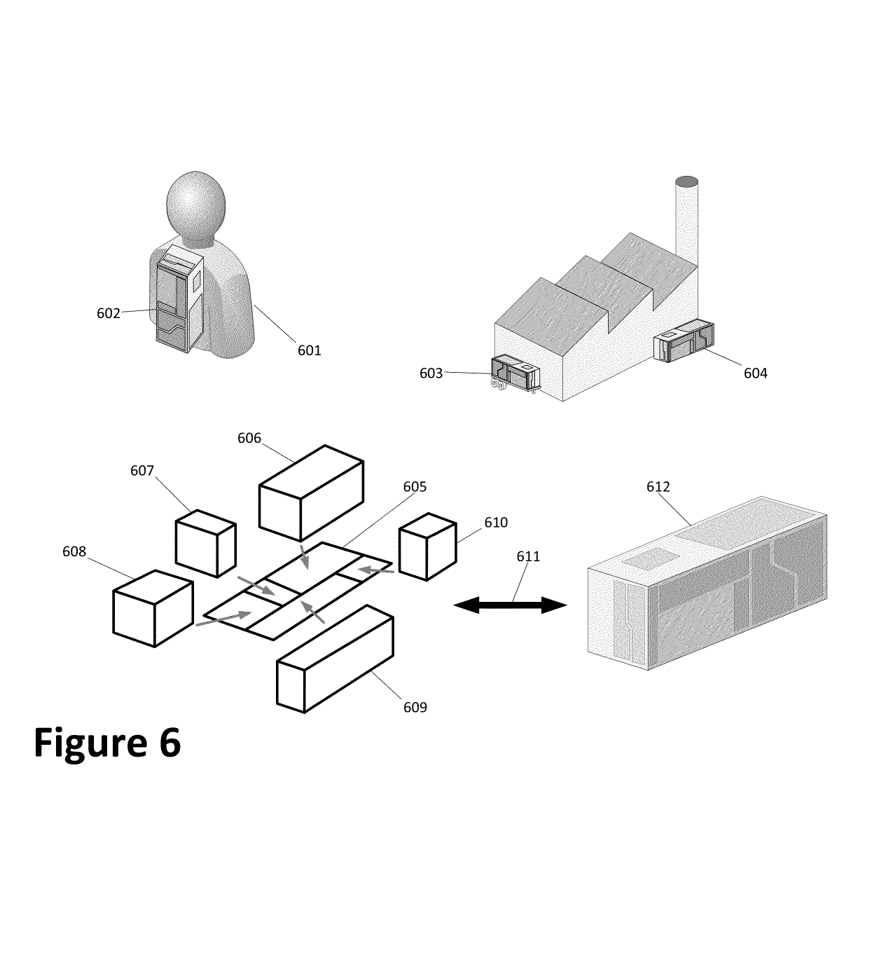

In some embodiments, as shown in FIG. 5, some or all of the modules 501, 507, 509 may be mounted on vehicles 506, 509 or trailers 502, or installed in aircraft, boats, ships or other vehicles. In these situations the modules may use the vehicles power source as if it were a third party power source, or be completely integrated into the power system of the vehicle. It can be envisioned that various sizes of the invention will be transported in different ways. For instance, as shown in FIG. 6, very small implementations may be utilized by a single person 601 and carried in a bag or as a backpack 602. Larger versions may require large trucks or cranes to move. Modules mounted to vehicles may be attached permanently or simply secured for transport and removed for use. Modules connected to mobile platforms, manned or autonomous, may be able to connect with a network of modules to facilitate enhanced charging or to share generation resources. In the case of autonomous vehicles, this docking and undocking from the larger network may be completely automated.

In other embodiments, the system may be permanently installed in a structure on land 603 or at sea, or used as part of a submersible system. Permanent installations may be outside or inside a building and could be in industrial, commercial or residential settings. Semi-permanent installations may also be possible 604, whereby modules can be securely mounted at a site, and additional modules added or modules removed as demand dictates. For instance, this would be the case at a military forward operating base, where a network of modules would provide power for the entire base, installed in a secure and defensible manner, and as the base expanded, modules could be added to the grid. When the base was closed or reduced in size, these fortified modules could still be removed without shutting down the power grid or disassembling the modules.

Mechanically, each module may be designed to function as a single unit. However, for purposes of transportation or deployment, it may disassemble 605, or be reconfigurable 611 from a single physical construction 612 into separate physical parts 606-610 connected by power and data connections, depending on the embodiment. This still constitutes a single module in that it functions as an autonomous, self controlled unit. Modules may be upgradable without special tools, and may accept repairs and replacement subsystems in the field. For instance, if an energy storage subsystem becomes defective, or is superseded by a better technology, it may be removed and replaced in the field as a single part. Any other subsystem can be treated in a similar manner.

The physical connections to third party power sources or loads may be any of several varieties. These include temporary, permanent, and semi-permanent connections. Examples of temporary connections would be various NEC rated indoor and outdoor power connectors, simple two or three-pronged electrical plugs and sockets, quick disconnect devices, or NEMA rated out door or submersible connectors designed for rapid connection and disconnections. Both high and low voltage connections may be made, as well as a combination. Permanent connections may be made by crimping, soldering or using wire nuts to secure connections inside a junction box or other permanent electrical enclosure. Semi-permanent connections may be modular plugs that may be locked in place for safety or reliability but can be removed without disassembling infrastructure. Similarly connections between modules in a network or micro-grid may be of any of the above styles, or a mixture. Additionally connections may also be of any of the above styles, or a mixture, depending on the embodiment of the invention.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure such that structural and logical substitutions and changes may be made without departing from the scope of the disclosure. For example, method steps may be performed in a different order than is shown in the figures or one or more method steps may be omitted. Accordingly the disclosure and the figures are to be regarded as illustrative rather than restrictive.

Moreover although specific embodiments have been illustrated and described herein it should be appreciated that any subsequent arrangement designed to achieve the same or similar results may be substituted for the specific embodiments shown. This disclosure is intended to cover any and all subsequent adaptations or variations of various embodiments. Combinations of the above embodiments and other embodiments not specifically described herein will apparent to those of skill in the art upon reviewing the description.

In the foregoing Detailed Description various features may be grouped together or described in an embodiment for the purpose of streamlining the disclosure. This disclosure is not to be interpreted as reflecting an intention that the claimed embodiments requiring more features are expressly recited in each claim. Rather as the claims reflect the claimed subject matter they may be directed at less than all of the features of any of the disclosed embodiments.

I claim:

1. An apparatus for managing energy comprising:
a module, the module comprising:
a controller;
a sensor;
a power distributor; and
an energy storage device,
wherein the sensor communicates environmental condition information to the controller;
wherein the controller performs at least one of minimizing fuel consumption, minimizing consumption of grid power, maximizing energy sold to the grid, minimizing cost, and maximizing stored energy, at least based upon the environmental condition information communicated by the sensor; and
wherein the controller directs the power distributor to distribute power from the energy storage device.

2. The apparatus of claim 1, wherein the module is enclosed in at least one of a modularly and monolithically.

3. The apparatus of claim 1, wherein the module communicates with other modules.

4. The apparatus of claim 1, wherein the module records the performance of the module.

5. The apparatus of claim 1, wherein the module reports the performance of the module.

6. The apparatus of claim 1, further comprising connections for external devices.

7. The apparatus of claim 1, wherein the module is associated with a transport device.

8. The apparatus of claim 1, further comprising at least one of artificial intelligence algorithms and active learning algorithms associated with the controller.

9. The apparatus of claim 1, wherein the sensor is at least one of geolocation hardware, a light sensor, a temperature sensor, a pressure sensor and a connection to an internet source of information.

10. The apparatus of claim 1, further comprising a source of power, wherein the source of power is at least one of connected to the module and managed by the module.

11. A method for managing energy by a module comprising:
a step of controlling the module;
a step of sensing environmental conditions for the module;
a step of distributing power for the module; and
a step of storing energy for the module,
wherein the controlling of the module includes performing at least one of minimizing fuel consumption, minimizing consumption of grid power maximizing energy sold to the grid, minimizing cost, and maximizing stored energy, at least based upon the environmental conditions determined by the step of sensing; and
wherein the controlling of the module includes distributing power for the module from the stored energy of the module.

12. The method for managing energy by a module of claim 11, further comprising a step of enclosing the module in at least of a modularly and monolithically.

13. The method for managing energy by a module of claim 11, further comprising a step of communicating with other modules.

14. The method for managing energy by a module of claim 11, further comprising a step of recording the performance of the module.

15. The method for managing energy by a module of claim 11, further comprising a step of reporting the performance of the module.

16. The method for managing energy by a module of claim 11, further comprising a step of utilizing at least one of artificial intelligence algorithms and active learning algorithms.

17. The method for managing energy by a module of claim 11, wherein the step of sensing is performed by at least one of geolocation hardware, a light sensor, a temperature sensor, a pressure sensor and a connection to an internet source of information.

18. The method for managing energy by a module of claim 11, further comprising a step of sourcing power, wherein the sourced power is at least one of controlled by the module and connected to the module.

19. A system for managing energy comprising:
a module, the module comprising:
a controlling means;
a sensing means;
a power distribution means; and
an energy storage means,
wherein the sensing means communicates environmental condition information to the controlling means;
wherein the controlling means performs at least one of minimizing fuel consumption, minimizing consumption of grid power maximizing energy sold to the grid, minimizing cost, and maximizing stored energy, at least based upon the environmental condition information communicated by the sensing means; and
wherein the controlling means directs the power distribution means to distribute power from the energy storage means.

20. The system of claim 19, further comprising at least one of artificial intelligence algorithms means and active learning algorithms means associated with the controlling means.
